(19) United States
(12) Patent Application Publication
(10) Pub. No.: US 2026/0077327 A1
(43) Pub. Date: Mar. 19, 2026

(54) CHANNEL ASSEMBLY

(71) Applicant: VELOCYS TECHNOLOGIES LTD, Oxford (GB)

(72) Inventors: Thomas YUSCHAK, Plain City, OH (US); Jennifer L. MARCO, Plain City, OH (US); Jeffery D. MARCO, Plain City, OH (US); Michael MARCHIANDO, Plain City, OH (US); Paul W. NEAGLE, Plain City, OH (US); David L. HAUSHALTER, Kenton, OH (US); Mark F. HAUSHALTER, Kenton, OH (US); Gary GEMBALA, Strongsville, OH (US)

(21) Appl. No.: 19/112,853

(22) PCT Filed: Sep. 22, 2023
(86) PCT No.: PCT/EP2023/076291

§ 371 Date: Mar. 18, 2025

Related U.S. Application Data
(60) Provisional application No. 63/409,550, filed on Sep. 23, 2022.

(30) Foreign Application Priority Data
Nov. 3, 2022 (GB) 2216359.6

(51) Int. Cl. B01J 8/02

(52) U.S. Cl. CPC B01J 8/0207; B01J 8/0278; B01J 8/0285; B01J 2208/00212; B01J 2208/022

(57) ABSTRACT

A channel assembly for stacking with laminar heat exchange elements in a Fischer-Tropsch reactor comprises a corrugated sheet (1) lying against a plate (4/5) having an inner surface engaging the extremities of the corrugations of the sheet to define process microchannels between the corrugations, wherein the peaks and troughs of the corrugations are laterally offset from the central longitudinal axes of the channels, and taller than the outer edge plates (3). This ensures that pressure (arrows A) applied during manufacture to the corrugated sheet bows the walls of the process microchannels in the same direction, maintaining a substantially constant cross-section, rather than towards each other with would reduce the cross section and create differential flow rates through the adjacent microchannels, whilst also maintaining enhanced thermal contact between the corrugations and the plates.

The present invention relates to an improved form of channel assembly, which is resistant to deformation during the manufacturing process, particularly but not exclusively for a chemical reactor such as a Fischer-Tropsch reactor for example.

It is well-known in the art to form a transverse array of process microchannels in a corrugated sheet of, e.g. copper, formed into a stack between metal plates which are welded around their extremities. In this manufacturing process considerable pressure is typically applied to hold the corrugated sheets in contact with the metal plates. The applied pressure frequently results in the deformation of the corrugated sheets peaks and troughs, not always in a predictable manner. In particular, there is a risk of adjacent walls of a channel buckling inwards, thereby reducing the cross-section of that channel and increasing the cross-section of adjacent channels. Deformation of the waveforms can result in uneven flow patterns in the reactor, which are known to be highly unfavourable in microchannel reactors.

The deformation of standard waveforms is illustrated in FIG. 2, which shows, in transverse cross-section, a corrugated copper sheet 1′ sandwiched between horizontally disposed upper and lower support plates 4 to define flow channels within the corrugations. During manufacture, pressure is applied to the plates 4, forcing them against the extremities of the corrugations 1′ to compress the corrugated sheet and ensure thermal contact at the lines of contact between the support plates 4 and sheet 1′. Because the central longitudinal axes X are laterally coincident with the peaks P and troughs T of the corrugations, the side walls of the channels are nearly vertical and hence this pressure tends to buckle them unpredictably in the plane of the assembly in either direction, as shown by arrows a. The undesirable buckling affect will also likely be seen in arrangements where the corrugated copper sheet 1′ has a Gaussian shape, and where the Gaussian shape is asymmetric or symmetric with respect to a centre line intersecting a top point of the peak P or trough T.

It is statistically likely that the direction of buckling in some channels will be inward, as indicated in chain-dotted lines in the left hand channel. This will reduce the transverse cross-section of that channel, and increase the transverse cross-section of the adjacent channels, creating significantly uneven patterns which are undesirable. Additionally, inward buckling of the channel wall undesirably decreases the channels accessibility, for example, when catalyst loading or unloading.

EP4089359 describes a plate for a plate kind heat exchanger. The plate kind heat exchanger comprises a plurality of plates comprising a plurality of corrugations arranged in a stacked configuration, where the hills and valleys formed in the plates define flow paths between the plates.

There is no consideration provided in this document of how to prevent buckling or provide an improved channel assembly. Therefore, there remains a need for the provision of a channel assembly with improved buckling resistance compared to arrangements of the prior art.

Welded microchannel reactors such as those exemplified in U.S. Pat. No. 9,174,387 detail that in the fabrication process stacks of alternating coolant panels and waveforms are aligned, and then are subsequently compressed prior to welding, for example by TIG welding, MIG welding, laser welding, amongst others. Welding occurs around the edge of the stack, where the metal plates that comprise the containment, for the corrugated waveforms, are in contact with one another. However, in such situations, the pressure applied to the stack can result in deformation of the component waveforms, which is undesirable.

An object of the present invention is to provide an improved channel assembly and method of construction, which is highly resistant to waveform deformation during the fabrication process, particularly during the compression step immediately prior to and during welding of the stack of metal plates.

The present invention provides an improved channel assembly comprising a corrugated sheet lying against a plate having an inner surface engaging the extremities of the corrugations of the sheet to define flow channels between the corrugations, wherein the peaks and troughs of the corrugations are laterally offset from the central longitudinal axes of the channels. The corrugations are also oversized relative to the interstitial space between the plates they are disposed between, with the height of the peaks of the waveform greater than the height of the metal edge strips.

Laterally offsetting the peaks and troughs of the waveform corrugation prevents the walls of any particular channel from both buckling towards each other when pressure is applied (e.g. during manufacture) to the extremities (peaks and troughs) of the corrugations. Corrugations as described therefore act like a spring to absorb compression in a controlled manner, compressing as much as 10% whilst also maintaining the specified channel gap. The maintenance of the specified channel gap promotes even space between the channels and maintains accessibility for catalyst loading and unloading. The ‘spanked’ corrugations as described herein are oversized relative to the plates between which they are placed, and as a result, upon compression of the stack, the corrugations also compress. Following welding of the edges of the component plates of the stack, when pressure is released, the corrugations remain compressed. As a result of the pressure they exert on the containment plates, they maintain improved thermal contact with the support plates and are held in place by the pressure of deformation.

Preferably, facing inner surfaces of a flow channel are concave and convex respectively. This configuration has advantageously been found to be particularly effective in the prevention of buckling of the channel walls when compared to configurations of the prior art. The concave and convex configuration of the inner surfaces of the flow channel has surprisingly been found to prevent buckling of the channel walls when pressure is applied. This arrangement provides a controlled uniform compression of the channels when pressure is applied, which, in turn, provides even flow channels and increases accessibility of the channels, which for example increases the ease of catalyst loading and unloading (when required).

Preferably the corrugated sheet is compressed between two plates. In this embodiment, the corrugated sheet may engage the inner surface of both plates i.e., the corrugated sheet may lie against an upper plate having an inner surface engaging the upper extremities of the corrugations of the sheet (for example, the channel wall peaks) and lie against a lower plate having an inner surface engaging the lower extremities of the corrugations of the sheet (for example, the channel wall troughs). This configuration has advantageously been found to promote uniform compression.

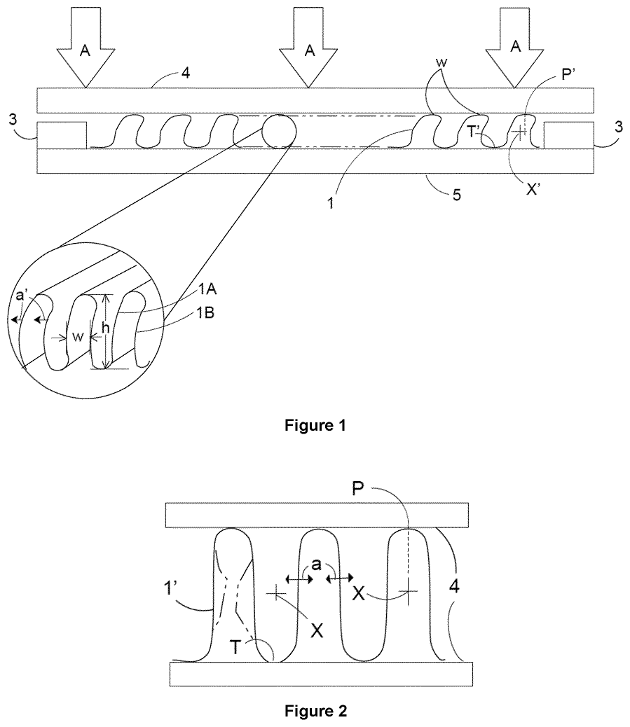

This is illustrated in FIG. 1, which shows corrugated copper sheet 1 sandwiched between horizontally disposed upper and lower support plates 4 and 5, and laterally disposed edge strips 3, to define flow channels within the corrugations. The peaks P′ and troughs T′ of corrugated sheet 1 are laterally offset about longitudinal axes X, with concave and convex side walls laterally offset, as indicated by arrows a′. During manufacture, pressure (indicated by arrow A) is applied to the plates 4 and 5, forcing them against the extremities of the corrugations 1 and the top of the edge strips 3. The corrugations 1 compress ensuring a fluid-tight seal at the lines of contact W between the support plates 4 and 5, and sheet 1. Spanked waveforms as described resist deformation upon pressure application, ensuring consistent transverse cross-sectional areas for the microchannels.

The problem addressed by the invention is particularly acute when the corrugated sheet has relatively deep corrugations, as in a Fischer-Tropsch reactor for example. Accordingly, the height to width ratio of the flow channels in the corrugated sheet is preferably at least 1.5, preferably at least 2.0, more preferably at least 3.0, most preferably at least 5.0.

Preferably the corrugated sheet is formed of a high thermal conductivity metal or alloy which is preferably copper or aluminium, or may be stainless steel.

Preferably the plates are formed of stainless steel.

Preferably each flow channel has a transverse cross-section whose width varies by less than ±20%, preferably by less than ±15% over at least the middle 50% of its height. This feature ensures relatively uniform flow when the flow paths are in parallel.

The width of the flow channels may be in the range 0.5 mm to 10 mm, preferably 0.5 mm to 5 mm, most preferably 0.5 mm to 1.5 mm when the channel assembly is for use in a Fischer-Tropsch microchannel reactor but may be substantially different in other reactor applications.

Preferably the thickness of the material of said corrugated sheet is in the range 0.05 mm to 2 mm, preferably 0.1 mm to 1 mm, for example 0.15 mm. In this range, the invention is particularly effective in preventing inward buckling upon the application of pressure during the fabrication process. when the channel assembly is for use in a Fischer-Tropsch microchannel reactor but may be substantially different in other reactor applications.

In some embodiments, the channel assembly may comprise at least one corrugated sheet, for example a plurality of corrugated sheets. In an embodiment where at least one corrugated sheet is present, the corrugated sheets are preferably located side by side and/or underneath and above one another and between plates (i.e. spacer plates). Accordingly, when at least one corrugated sheet is present, the corrugated sheets are not in direct contact with one another. The arrangement advantageously has been found to prevent the occurrence of buckling, promote uniform compression and contact with the heat transfer plates, and provide accessibility for catalyst loading and unloading.

Further preferred features are defined in the dependent claims.

### DETAILED DESCRIPTION

Preferred embodiments of the invention are described below by way of example only with reference to FIGS. 1 to 7 of the accompanying drawings, wherein:

FIG. 1 (already referred to) is a diagrammatic cross section illustrating the manufacture of a channel assembly of an embodiment of the invention;

FIG. 2 (already referred to and outside the scope of the present invention) is a schematic cross-section of a channel assembly including a corrugated sheet sandwiched between two support plates;

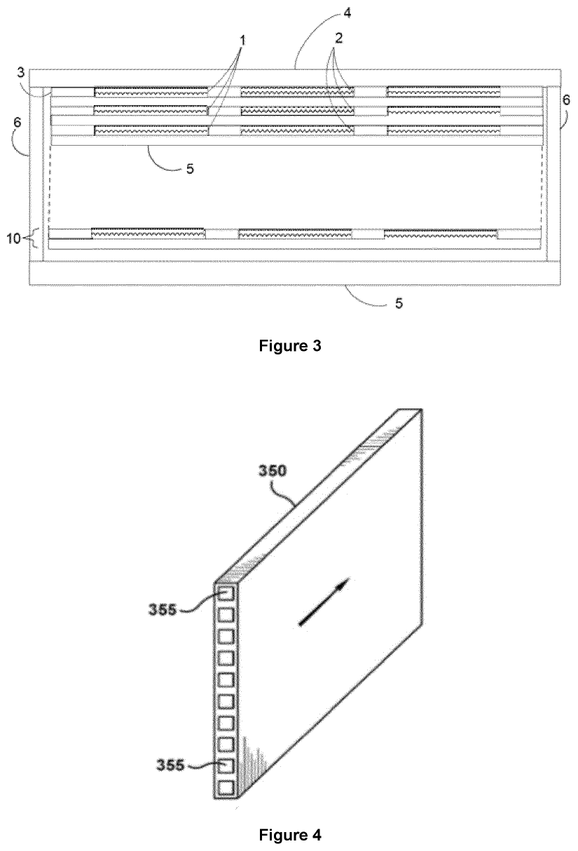

FIG. 3 is a diagrammatic transverse cross-section of an embodiment of a complete channel assembly;

FIG. 4 is a perspective view of a heat exchange unit that can be combined with a micro-channel assembly of an embodiment shown in FIG. 5 for use in a Fischer-Tropsch reactor;

FIG. 5 is a perspective view of a microchannel assembly of an embodiment for use in a Fischer-Tropsch reactor;

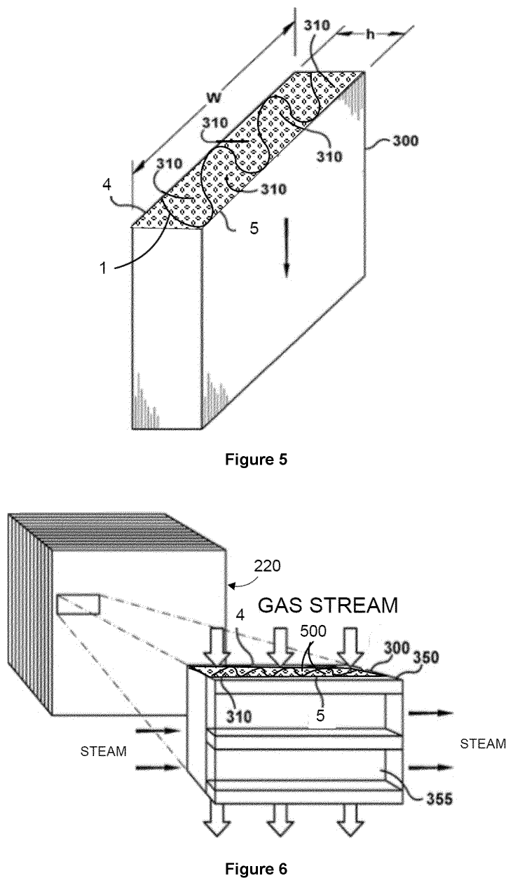

FIG. 6 is a perspective view of a block comprising multiple combined microchannel and heat exchanger assemblies as shown in FIGS. 4 and 5, and

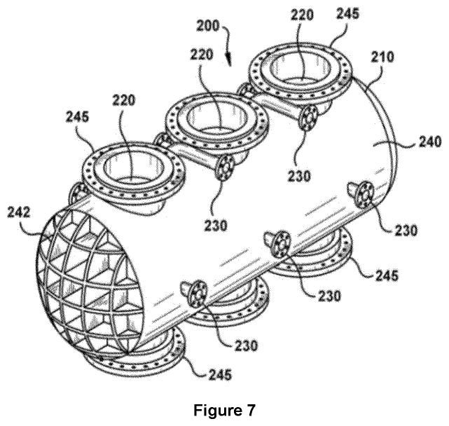

FIG. 7 is a perspective view of a Fischer-Tropsch reactor incorporating the blocks of FIG. 6.

Referring to FIG. 1, a corrugated sheet of copper 1 of metal thickness 150 μm is located, on spacer plate 5 between two stainless steel edge strips 3. The edge strips 3 have a height that is slightly less than the height, h, of the corrugated sheet 1. As shown in FIG. 1, the peaks P′ and troughs T′ of the corrugations of sheet 1 are laterally displaced relative to the associated longitudinal centres X′ of the corrugations.

Furthermore the opposite wall surfaces of each channel are concave and convex respectively. The depicted embodiment shows a single symmetrically repeating corrugation unit, but it would also be possible for neighbouring corrugation units to have mirror image symmetry with each other.

The width w of the channels is suitably 1 mm and the height h is suitably 6.5 mm.

An upper spacer plate 4, similar to the lower spacer plate 5, is located above the corrugated sheet 1 and pressed downwardly in a press, as indicated by arrows A, until the corrugations are distorted sufficiently to allow upper spacer plate 5 to contact edge strips 3. This distortion involves bowing of opposite channel sides in the same direction a′ as indicated in FIG. 1, this direction being determined by the curvature of the channel sides, and is to be contrasted with the distortion (possibly buckling) of straight profile channel sides in either direction a as indicated in FIG. 2 as noted above. Inward collapse of the channel walls is thereby largely prevented.

The above pressing process results in a line contact between each peak/trough of corrugated sheet 1 and its associated upper or lower plate 4/5 which enables close (thermal) contact (by residual pressure) of the channels upon welding of the upper/lower plate 4/5 with the edge strips 3.

In fact, because the peaks P′ and troughs T′ are offset from the longitudinal centres X′, the upper and lower extremities of the side walls of the channels also contact the plates 4 and 5, so the thickness of the region of line contact is greater than in the configuration shown in FIG. 2. This increase in the thickness (width) of the region of line contact improves the thermal contact between the corrugated sheet and the plates 4 and 5, which is especially advantageous in a chemical reactor such as a Fischer-Tropsch reactor, for example.

In a variant, multiple (e.g. three) corrugated sheets are located side by side in a stack between repeating spacer plates 4 and 5 and edge strips 3 with further edge strips 2 between each of the corrugated sheets as shown in FIG. 3. The uppermost and lowermost plates are connected by corner posts 6 which maintain the corrugated sheets 1 under compression, with the result that they are held in sealing contact against the spacer plates.

The complete stack is made up of repeating units 10 of a spacer plate 5, on which a central corrugated sheet 1 is supported between two edge strips 2, flanked by two further corrugated sheets 1 which are bounded by edge strips 3.

In a variant, prior to the stacking of the repeating units 10, the corrugated sheets are secured with a temporary tack weld to the lower spacer plate 5 at the ends of each waveform, in the trough closest to the edge/spacer strips 2/3. The temporary tack weld aids in securing the waveform in place during the subsequent stacking, pressurization and welding steps, facilitating maintenance of thermal contact and mechanically stable placement of plates.

In a variant, each repeating unit 10 may alternate in the stack with a laminar heat exchange unit 350 as shown in FIG. 4, which is provided with channels 355 for a heat exchange fluid (e.g. steam) and is oriented and dimensioned such that the channels 355 are orthogonal to the channels of the corrugated sheets 1. This takes advantage of the improved thermal contact noted above between the spanked channels and the plates in contact, providing more effective heat exchange between the process channels and the heat exchange fluid. Alternatively, the plates themselves may be provided with channels for heat exchange fluid.

Channel assemblies in accordance with the invention are suitable for use in Fischer-Tropsch reactors, e.g. as process microchannel units.

The Fischer-Tropsch process is widely used to generate fuels from carbon monoxide and hydrogen and can be represented by the equation:

$$( 2 n + 1 ) {H}_{2} + n CO \to {C}_{n} {H}_{2 n + 2} + {n H}_{2} O$$

This reaction is highly exothermic and is catalysed by a Fischer-Tropsch catalyst, typically a cobalt-based catalyst, under conditions of elevated temperature (typically at least 180° C., e.g. 200° C. or above) and pressure (e.g. at least 10 bar). A product mixture is obtained, and n typically encompasses a range from 1 to 120. It is desirable to minimise methane selectivity, i.e. the proportion of methane (n=1) in the product mixture, and to maximise the selectivity towards C5 and higher (n>5) paraffins, preferably to a level of 90% or higher. It is also desirable to maximise the conversion of carbon monoxide.

The hydrogen and carbon monoxide feedstock is normally synthesis gas, and can be obtained from a range of carbonaceous sources, including biomass and solid municipal waste.

Referring to FIG. 5, a process microchannel unit 330 in accordance with the invention is shown, comprising a spanked corrugated sheet 1 sandwiched between support plates 4 and 5 and defining process microchannels 310 on either side of sheet 1. Each microchannel 310 is packed with catalyst 500 (FIG. 6). Fischer-Tropsch catalyst 500 may be in any form including fixed beds of particulate solids or various structured catalyst forms.

The Fischer-Tropsch catalyst 500 may optionally comprise cobalt and a support. The catalyst may optionally have a Co loading in the range from about 10 to about 60% by weight, or from about 15 to about 60% by weight, or from about 20 to about 60% by weight, or from about 25 to about 60% by weight, or from about 30 to about 60% by weight, or from about 32 to about 60% by weight, or from about 35 to about 60% by weight, or from about 38 to about 60% by weight, or from about 40 to about 60% by weight, or from about 40 to about 55% by weight, or about 40 to about 50% of cobalt.

The Fischer-Tropsch catalyst 500 may optionally further comprise a noble metal. The noble metal may be one or more of Pd, Pt, Rh, Ru, Re, Ir, Au, Ag and Os. The noble metal may be one or more of Pd, Pt, Rh, Ru, Re, Ir, and Os. The noble metal may be one or more of Pt, Ru and Re. The noble metal may be Ru. It may be Re. As an alternative, or in addition, the noble metal may be Pt. The Fischer-Tropsch catalyst may optionally comprise from about 0.01 to about 30% in total of noble metal(s) (based on the total weight of all noble metals present as a percentage of the total weight of the catalyst precursor or activated catalyst), or from about 0.05 to about 20% in total of noble metal(s), or from about 0.1 to about 5% in total of noble metal(s), or about 0.2% in total of noble metal(s).

The Fischer-Tropsch catalyst 500 may optionally include one or more other metal-based components as promoters or modifiers. These metal-based components may optionally also be present in the catalyst precursor and/or activated catalyst as carbides, oxides or elemental metals. A suitable metal for the one or more other metal-based components may, for example, be one or more of Zr, Ti, V, Cr, Mn, Ni, Cu, Zn, Nb, Mo, Cd, Hf, Ta, W, Re, Hg, TI and the 4f-block lanthanides. Suitable 4f-block lanthanides may be La, Ce, Pr, Nd, Sm, Eu, Gd, Tb, Dy, Ho, Er, Tm, Yb and/or Lu. The metal for the one or more other metal-based components may for example be one or more of Zn, Cu, Mn, Mo and/or W. The metal for the one or more other metal-based components may for example be one or more of Re and/or Pt. The catalyst may optionally comprise from about 0.01 to about 10% in total of other metal(s) (based on the total weight of all the other metals as a percentage of the total weight of the catalyst precursor or activated catalyst), or optionally from about 0.1 to about 5% in total of other metals, or optionally about 3% in total of other metals.

The Fischer-Tropsch catalyst 500 may optionally include a catalyst support. The support may optionally comprise alumina, zirconia, silica, titania, or a mixture of two or more thereof. The surface of the support may optionally be modified by treating it with silica, titania, zirconia, magnesia, chromia, alumina, or a mixture of two or more thereof. The material used for the support and the material used for modifying the support may be different. The support may optionally comprise silica and the surface of the silica may be treated with an oxide refractory solid oxide such as titania. The material used to modify the support may be used to increase the stability (e.g. by decreasing deactivation) of the supported catalyst. The catalyst support may optionally comprise up to about 30% by weight of the oxide (e.g., silica, titania, magnesia, chromia, alumina, or a mixture of two or more thereof) used to modify the surface of the support, or from about 1% to about 30% by weight, or from about 5% to about 30% by weight, or from about 5% to about 25% by weight, or from about 10% to about 20% by weight, or from about 12% to about 18% by weight, for example. The catalyst support may optionally be in the form of a structured shape, pellets or a powder. The catalyst support may optionally be in the form of particulate solids. While not wishing to be bound by theory, it is believed that the surface treatment provided for herein helps keep the Co from sintering during operation of the Fischer-Tropsch process. The median particle diameter may optionally be in the range from 50 to about 500 μm or about 100 to about 500 μm, or about 125 to about 400 μm, or about 170 to about 300 μm. In one embodiment, the catalyst may be in the form of a fixed bed of particulate solids.

Microchannel reactors are disclosed in WO2016/201218A, in the name of the present applicant, which is incorporated by reference, and similarly in LeViness et al. “Velocys Fischer-Tropsch Synthesis Technology—New Advances on State-of-the-Art” Top. Catal. 2014, 57 pp 518-525. Such reactors have the particular advantage that very effective heat removal is possible, owing to the high ratio of heat exchange surface area to microchannel (and hence catalyst) volume. According to the present invention, the compression of the spanked channels of corrugated sheet 1 ensures good thermal contact with adjacent heat exchange layers, which facilitates enhanced process control.

Further details of a suitable microchannel reactor are given below with reference to FIGS. 6 and 7.

Referring to FIG. 6, a microchannel reactor core 220 for use in a Fischer-Tropsch reactor is shown and contains a stack of alternating laminar units 300 (see FIG. 5) of process microchannels 310 and laminar units 350 (see FIG. 4) of heat exchange channels 355.

The microchannel reactor core 220 may optionally comprise a plurality of plates in a stack defining a plurality of process layers and a plurality of heat exchange layers, each plate having a peripheral edge, the peripheral edge of each plate or shim being welded to the peripheral edge of the next adjacent plate to provide a perimeter seal for the stack. This is shown in US2012/0095268 A1, which is incorporated herein by reference.

The microchannel reactor core 220 may optionally have the form of a three-dimensional block which has six faces that are squares or rectangles. The microchannel reactor core 220 may optionally have the same cross-section along a length. The microchannel reactor core 220 may optionally be in the form of a parallel or cubic block or prism.

Referring to FIG. 7, microchannel reactor 200 comprises containment vessel 210 which contains or houses three microchannel reactor cores 220. In other embodiments, containment vessel 210 may be used to contain or house from 1 to about 12 microchannel reactor cores, or from 1 to about 8 microchannel reactor cores, or from 1 to about 4 microchannel reactor cores. The containment vessel 210 may be a pressurizable vessel. The containment vessel 210 includes inlets and outlets 230 allowing for the flow of reactants into the microchannel reactor cores 220, product out of the microchannel reactor cores 220, and heat exchange fluid into and out of the microchannel reactor cores 220.

One of the inlets 230 may be connected to a header or manifold (not shown) which is provided for flowing reactants to process microchannels in each of the microchannel reactor cores 220. One of the inlets 230 is connected to a header or manifold (not shown) which is provided for flowing a heat exchange fluid, e.g. superheated steam, to heat exchange channels in each of the microchannel reactor cores 220. One of the outlets 230 is connected to a manifold or footer (not shown) which provides for product flowing out of the process microchannels in each of the microchannel reactor cores 220. One of the outlets 230 is connected to a manifold or footer (not shown) to provide for the flow of the heat exchange fluid out of the heat exchange channels in each of the microchannel reactor cores 220.

The containment vessel 210 may be constructed using any suitable material sufficient for countering operating pressures that may develop within the microchannel reactor cores 220. For example, the shell 240 and reinforcing ribs 242 of the containment vessel 210 may be constructed of cast steel. The flanges 245, couplings and pipes may be constructed of 316 stainless steel for example.

The microchannel reactor core 220 may be fabricated using known techniques including for example wire electro-discharge machining, conventional machining, laser cutting, photochemical machining, electrochemical machining, moulding, waterjet, stamping, etching (e.g., chemical, photochemical or plasma etching), 3D printing and combinations thereof.

The microchannel reactor core 220 may optionally be constructed by forming plates with portions removed that allow flow passage. A stack of plates may, for example, be assembled via diffusion bonding, laser welding, diffusion brazing, and similar methods to form an integrated device. The microchannel reactors may for example be assembled using a combination of plates and partial plates or strips. In this method, the channels or void areas may be formed by assembling strips or partial plates to reduce the amount of material required.

The microchannel reactor core 220 may optionally comprise a plurality of plates in a stack defining a plurality of process layers and a plurality of heat exchange layers, each plate having a peripheral edge, the peripheral edge of each plate or shim being welded to the peripheral edge of the next adjacent plate to provide a perimeter seal for the stack. This is shown in US2012/0095268 A1, which is incorporated herein by reference.

The containment vessel 210 may optionally include a control mechanism to maintain the pressure within the containment vessel at a level that is at least as high as the internal pressure within the microchannel reactor cores 220 and/or the pressure within any associated coolant channels. The internal pressure within the containment vessel 210 may optionally be in the range from about 10 to about 60 atmospheres, or from about 15 to about 30 atmospheres during the operation of a synthesis gas conversion process (e.g., Fischer-Tropsch process). The control mechanism for maintaining pressure within the containment vessel may optionally comprise a check valve and/or a pressure regulator. The check valve or regulator may optionally be programmed to activate at any desired internal pressure for the containment vessel. Either or both of these may be used in combination with a system of pipes, valves, controllers, and the like, to ensure that the pressure in the containment vessel 210 is maintained at a level that is at least as high as the internal pressure within the microchannel reactor cores 220. This is done in part to protect welds used to form the microchannel cores 220. A significant decrease in the pressure within the containment vessel 210 without a corresponding decrease of the internal pressure within the microchannel reactor cores 220 could result in a costly rupture of the welds within the microchannel reactor cores 220. The control mechanism may optionally be designed to allow for diversion of one or more process gases into the containment vessel in the event the pressure exerted by the containment gas decreases.

Because the channels of the channel assemblies of the invention have a very uniform transverse cross-section, owing to the resistance to crumpling afforded by the spanked nature of the waveform, they permit even packing of the catalyst and thereby facilitate uniform flow rates in the channels of a chemical (e.g. Fischer-Tropsch) reactor, which maximises process efficiency.

1. A channel assembly comprising a corrugated sheet lying against a plate having an inner surface engaging the extremities of the corrugations of the sheet to define flow channels between the corrugations, wherein the peaks and troughs of the corrugations are laterally offset from the central longitudinal axes of the channels.

2. A channel assembly according to claim 1, wherein flow channels each have facing inner surfaces which are concave and convex respectively.

3. A channel assembly according to claim 1, wherein the corrugated sheet is compressed between two plates.

4. A channel assembly according to claim 1, wherein the corrugated sheet is formed of a high thermal conductivity metal or alloy.

5. A channel assembly according to claim 4, wherein the corrugated sheet is formed of copper or aluminium or stainless steel.

6. A channel assembly according to claim 1, wherein the or each plate is formed of stainless steel.

7. A channel assembly according to claim 1, wherein each flow channel has a transverse cross-section whose width varies by less than ±20%, preferably by less than ±15% over at least the middle 50% of its height.

8. A channel assembly according to claim 1, wherein the width of the flow channels is in the range 0.5 mm to 10 mm, preferably 0.5 mm to 5 mm, most preferably 0.5 mm to 1.5 mm.

9. A channel assembly according to claim 1, wherein the thickness of the material of said corrugated sheet is in the range 0.05 mm to 2 mm, preferably 0.1 mm to 1 mm.

10. A channel assembly stack comprising a stack of channel assemblies as claimed in claim 1, the corrugations of the channel assemblies preferably being parallel.

11. A channel assembly stack as claimed in claim 10, wherein said channel assemblies are held in contact with heat exchange elements which preferably alternate with said channel assemblies in the stack.

12. A channel assembly stack as claimed in claim 11, wherein said heat exchange elements comprise flow paths for a heat exchange fluid, which flow paths are preferably transverse to the corrugations of said channel assemblies.

13. A channel assembly or channel assembly stack according to claim 1, further comprising a reactant or a catalyst material in said flow channels.

14. A channel assembly or a channel assembly stack according to claim 1, wherein said flow channels communicate with a manifold arranged to pass streams of fluid in parallel through said flow channels.

15. A chemical reactor comprising a channel assembly or a channel assembly stack according to claim 13.

16. A chemical reactor according to claim 15, wherein said channel assembly or channel assembly stack is enclosed within a pressure vessel.

17. A chemical reactor according to claim 15, which is a Fischer-Tropsch reactor and wherein said catalyst material is a Fischer-Tropsch catalyst.

18. A Fischer-Tropsch reactor according to claim 17, wherein said plate is in thermal contact with a flow path for heat transfer fluid.
